(19) United States
(12) Patent Application Publication
(10) Pub. No.: US 2014/0374949 A1
(43) Pub. Date: Dec. 25, 2014

(54) THREE-DIMENSIONAL PRINTING APPARATUS AND PRINGING METHOD THEREOF

(71) Applicants: Cal-Comp Electronics & Communications Company Limited, New Taipei City (TW); Cal-Comp Precision (Singapore) Limited, Singapore (SG); Kinpo Electronics, Inc., New Taipei City (TW)

(72) Inventors: Cher-Lek Toh, SINGAPORE (SG); Wei-De Toh, SINGAPORE (SG)

(73) Assignees: Cal-Comp Precision (Singapore) Limited, Singapore (SG); Kinpo Electronics, Inc., New Taipei City (TW); Cal-Comp Electronics & Communications Company Limited, New Taipei City (TW)

(21) Appl. No.: 13/957,445

(22) Filed: Aug. 2, 2013

Related U.S. Application Data
(60) Provisional application No. 61/838,884, filed on Jun. 25, 2013.

(51) Int. Cl. B29C 67/00

(52) U.S. Cl. CPC B29C 67/0088
USPC 264/241; 425/375

(57) ABSTRACT

A three-dimensional printing apparatus suitable for fabricating a three-dimensional object from a model of the three-dimensional object is provided. The three-dimensional printing apparatus includes a rotary base and a printing head. The rotary base has a carrying surface and is configured to rotate about a first axis and shift along the first axis. The printing head is disposed above the rotary base and configured to shift along a second axis perpendicular to the first axis for dispensing successive layers of building material onto the carrying surface. The successive layers of building material form the three-dimensional object. The shape of each layer of the building material is decided by the rotation of the rotary base about the first axis, the shifting of the rotary base along the first axis and the shifting of the printing head along the second axis. A printing method for the three-dimensional printing apparatus is also provided.

### CROSS-REFERENCE TO RELATED APPLICATION

This application claims the priority benefits of U.S. provisional application Ser. No. 61/838,884, filed on Jun. 25, 2013. The entirety of the above-mentioned patent application is hereby incorporated by reference herein and made a part of this specification.

### BACKGROUND OF THE INVENTION

1. Field of the Invention

The present invention generally relates to a printing apparatus and a printing method thereof More particularly, the present invention relates to a three-dimensional printing apparatus and a printing method thereof.

2. Description of Related Art

There are many different technologies currently used to build physical three-dimensional (3-D) models using additive manufacturing technology, for example, building a model layer by layer. Typically, a virtual design of the 3-D model, for example, represented through computer-aided design (CAD) software or the like, is transformed into a plurality of thin (quasi-two-dimensional) cross-sectional layers which are built on one another in succession.

There are a number of known ways in which the thin cross-sectional layers may be formed. For example, a printing head is usually installed in a manner that it can be moved above a base in an X-Y coordinate to extrude or deposit material in correct shape of the cross-sectional layer by reference to an X-Y-Z coordinates constructed from the virtual design data. The deposited material may then harden naturally or be cured by, for example, powerful light source, to form the desired cross-sectional layer.

However, these technologies also impose limitations. For example, such planar layer additive technologies exhibit poor surface qualities due to X-Y plane terracing when 3-D models are in circular or curvy shape. Therefore, the conventional planar layer additive technologies are unsuitable for fabrication of three-dimensional objects with curvy contours. There remains a need for an apparatus capable of fabricating complex and curvy items having smooth surface.

### SUMMARY OF THE INVENTION

Accordingly, the present invention is directed to a three-dimensional printing apparatus which has better resolution and better printing quality.

The present invention is directed to a method for fabricating a three-dimensional object with better resolution and quality

The present invention provides a three-dimensional printing apparatus suitable for fabricating a three-dimensional object from a model of the three-dimensional object. The three-dimensional printing apparatus includes a rotary base and a printing head.

The rotary base has a carrying surface and is configured to rotate about a first axis and shift along the first axis. The printing head is disposed above the rotary base and configured to shift along a second axis perpendicular to the first axis for dispensing successive layers of building material onto the carrying surface. The successive layers of building material form the three-dimensional object. The dispensing shape of each layer of the building material is decided by the rotation of the rotary base about the first axis, the shifting of the rotary base along the first axis and the shifting of the printing head along the second axis.

The present invention further provides a method for fabricating a three-dimensional object by the three-dimensional printing apparatus described above. The method includes the following steps. Firstly, a model of the three-dimensional object including a plurality of cross sections is provided. Then, a plurality of moving parameters is obtained according to each cross section of the model. The printing head and the rotary base is controlled to move according to the moving parameters for the printing head to dispense successive layers of building material onto the carrying surface of the rotary base to form the three-dimensional object.

According to an embodiment of the present invention, the three-dimensional printing apparatus further includes a control unit, coupled to the rotary base and the printing head for controlling the movements of the rotary base and the printing head.

According to an embodiment of the present invention, the control unit controls the rotary base to rotate about the first axis according to a rotating parameter and controls the rotary base to shift along the first axis according to a first shifting parameter obtained from the model.

According to an embodiment of the present invention, the control unit controls the printing head to shift along the second axis according to a second shifting parameter obtained from the model.

According to an embodiment of the present invention, the three-dimensional printing apparatus further includes a pulley assembly, coupled to the control unit for carrying the printing head to shift along the second axis.

According to an embodiment of the present invention, the pulley assembly includes a belt and at least one pulley. The belt extends along the second axis, and the printing head is disposed thereon. The pulley is connected to the belt for driving the belt to move along the second axis.

According to an embodiment of the present invention, the three-dimensional printing apparatus further includes at least one motor, coupled to the control unit and connected to the rotary base for driving the rotary base to shift along the first axis and rotate about the first axis.

According to an embodiment of the present invention, the motor further includes a first motor and a second motor. The first motor drives the rotary base to shift along the first axis, and the second motor drives the rotary base to rotate about the first axis.

According to an embodiment of the present invention, the first axis is parallel to a normal vector of the carrying surface.

According to an embodiment of the present invention, the second axis is parallel to the carrying surface.

According to an embodiment of the present invention, the three-dimensional printing apparatus further includes a spool for providing the building material to the printing head.

According to an embodiment of the present invention, the moving parameters include a rotating parameter, a first shifting parameter and a second shifting parameter.

According to an embodiment of the present invention, the step of controlling the movements of the printing head and the rotary base according to the moving parameters includes the following steps. Firstly, the rotary base is controlled to rotate about the first axis according to a rotating parameter. Next, the rotary base is controlled to shift along the first axis according to a first shifting parameter obtained from the model.

According to an embodiment of the present invention, the step of controlling the movements of the printing head and the rotary base according to the moving parameters includes that the printing head is controlled to shift along the second axis according to a second shifting parameter obtained from the model.

According to an embodiment of the present invention, the successive layers of building material correspond to the cross sections of the model respectively.

Based on the description described above, in the present invention, the rotary base of the 3-D printing apparatus is suitable for shifting along and rotating about the first axis and the printing head is suitable for shifting along the second axis according to the cross sections of the model of the 3-D object, while the printing head dispenses successive layers of building material onto the rotary base to form the 3-D object from the model. Thereby, unlike the conventional 3-D printing apparatus which the base thereof is not rotatable and can only shift along the X-Y coordinates, the 3-D printing apparatus having the rotatable rotary base can provide better surface qualities without X-Y plane terracing when 3-D models are in circular or curvy shape. Therefore, the 3-D printing apparatus of the present invention has better resolution and better printing quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a perspective view of a three-dimensional printing apparatus according to an embodiment of the invention.

FIG. 2 illustrates a perspective view of the three-dimensional object in FIG. 1.

FIG. 3 illustrates a perspective view of the rotary base in FIG. 1.

FIG. 4 illustrates a flow chart of a method for fabricating a three-dimensional object by the three-dimensional printing apparatus in FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

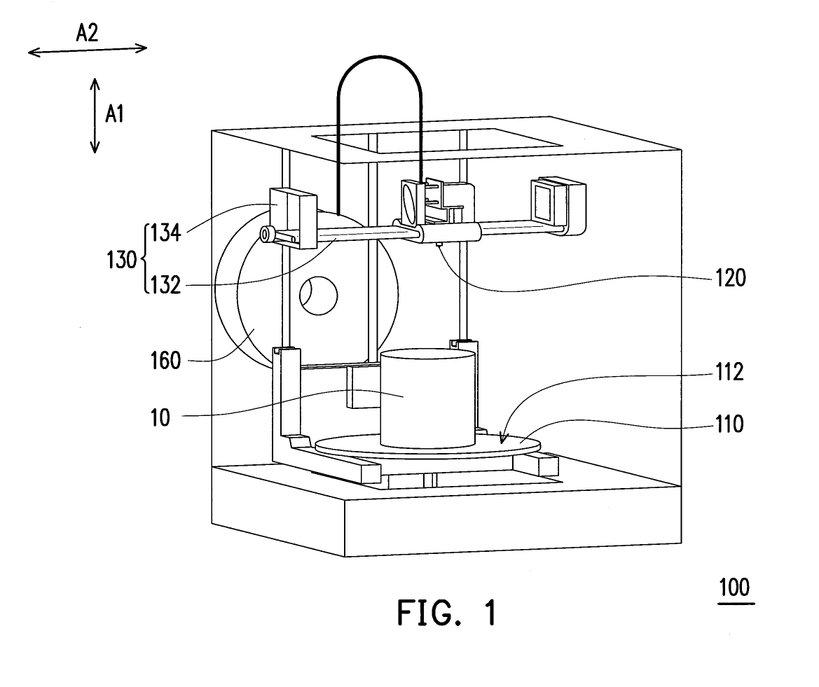

FIG. 1 illustrates a perspective view of a three-dimensional printing apparatus according to an embodiment of the invention. Referring to FIG. 1, in the present embodiment, the three-dimensional (3-D) printing apparatus 100 is suitable for fabricating a three-dimensional (3-D) object 10 from a model (not shown) of the 3-D object 10. The model may be built by, for example, computer aided design (CAD) or animation modeling software, etc., and the model is sliced into a plurality of cross sections for the 3-D printing apparatus 100 to use as a guideline for printing, such that the 3-D printing apparatus 100 reads the model to fabricate the 3-D object 10 from the cross sections of the model.

In the present embodiment, the 3-D printing apparatus 100 includes a rotary base 110 and a printing head 120. The rotary base 110 has a carrying surface 112 for carrying the building material from the printing head 120. The rotary base 110 is suitable for rotating about a first axis A1 and shifting along the first axis A1. The printing head 120 is disposed above the rotary base 110 and configured to shift along a second axis A2 for dispensing successive layers of building material onto the carrying surface 112 to form the 3-D object 10. In the present embodiment, the 3-D printing apparatus 100 further includes a spool 160 for providing the building material to the printing head 120, and the building material includes liquid, powder, paper or sheet material or any other suitable material.

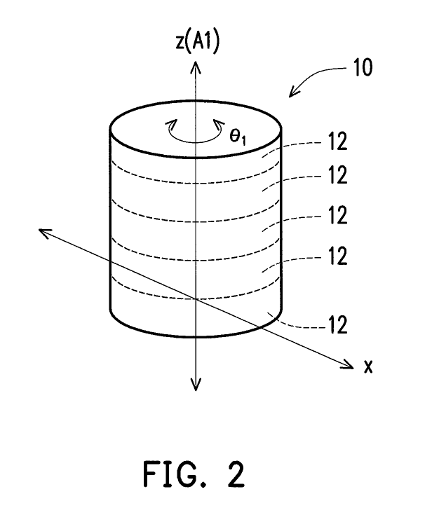

FIG. 2 illustrates a perspective view of the 3-D object in FIG. 1. Referring to both FIG. 1 and FIG. 2, in the present embodiment, the second axis A2 is perpendicular to the first axis A1. Herein, the first axis A1 is, for example, the Z-axis shown in FIG. 2, and is parallel to a normal vector of the carrying surface 112. As long as the second axis A2 is perpendicular to the first axis A1 and is parallel to the carrying surface 112, the present invention does not limit the direction of the first axis A1 and the second axis A2. The shape of each layer 12 of the building material shown in FIG. 2 is decided by the rotation of the rotary base 110 about the first axis A1, the shifting of the rotary base 110 along the first axis A1 and the shifting of the printing head 120 along the second axis A2. The X-Y-Z coordinates of the 3-D object 10 may respectively correspond to the X-Y-Z coordinates of the model of the 3-D object 10, and each layer 12 of the 3-D object 10 respectively correspond to a cross section of the model of the 3-D object 10, such that the successive layers 12 of the building material form the 3-D object 10.

In detail, the 3-D printing apparatus 100 further includes a control unit (not shown) coupled to the rotary base 110 and the printing head 120 for controlling the movements of the rotary base 110 and the printing head 120. To be specific, the control unit controls the rotary base 110 to rotate about the first axis A1 according to a rotating parameter θ₁ and controls the rotary base 110 to shift along the first axis A1 according to a first shifting parameter Z₁, wherein the rotating parameter θ₁ and the first shifting parameter Z₁ are obtained from the cross sections of the model. In addition, the control unit also controls the printing head 120 to shift along the second axis A2 according to a second shifting parameter Y₁ obtained from the cross sections of the model. Namely, the control unit controls the rotary base 110 to move according to the corresponding parameters θ₁, Z₁ obtained from the cross sections of the model, and controls the printing head 120 to move according to the corresponding parameters Y₁ obtained from the cross sections of the model, while the printing head 120 dispenses successive layers of building material onto the rotary base 110 to form the 3-D object 10 from the cross sections of the model.

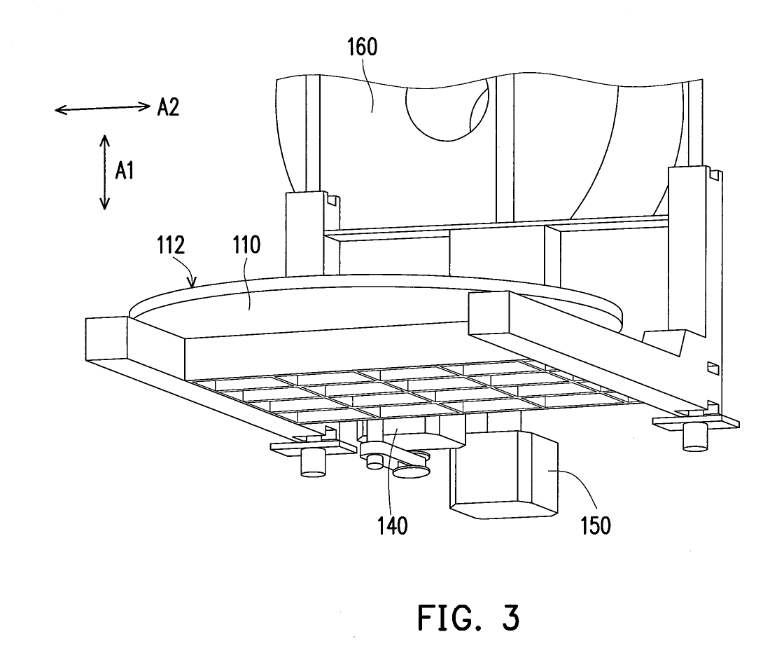

FIG. 3 illustrates a perspective view of the rotary base in FIG. 1. Referring to FIG. 1 and FIG. 3, in the present embodiment, the 3-D printing apparatus 100 may include a pulley assembly 130 which is coupled to the control unit. The pulley assembly 130 includes a belt 132 and at least one pulley 134. The printing head 120 is disposed on the belt 132 extending along the second axis A2. The pulley 134 connected to the belt 132 for driving the belt 132 to move along the second axis A2, so as to carry the printing head 120 to shift along the second axis A2 according to the second shifting parameter Y₁.

In addition, the 3-D printing apparatus 100 may further include at least one motor (illustrated as two motors 140, 150), which is coupled to the control unit and connected to the rotary base 110 for driving the rotary base 110 to shift along the first axis A1 and rotate about the first axis A1. In the present embodiment, the 3-D printing apparatus 100 includes a first motor 140 and a second motor 150 disposed under the rotary base 110 as shown in FIG. 3. The control unit controls the first motor 140 to drive the rotary base 110 to shift along the first axis A1 according to the first shifting parameter Z₁, and control the second motor 150 to drive the rotary base 110 to rotate about the first axis A1 according to the rotating parameter θ₁.

With the disposition described above, the 3-D printing apparatus 100 may control the rotary base 110 to shift along the first axis A1 and rotate about the first axis A1 according to the corresponding parameters Z₁, θ₁, and control the printing head 120 to shift along the second axis A2 according to the corresponding parameter Y₁, while the printing head 120 dispenses successive layers of building material onto the rotary base 110 to form the 3-D object 10 from the model. Thereby, the 3-D printing apparatus 100 can provide better surface qualities when 3-D models are in circular or curvy shape since the rotary base 110 are rotatable while printing.

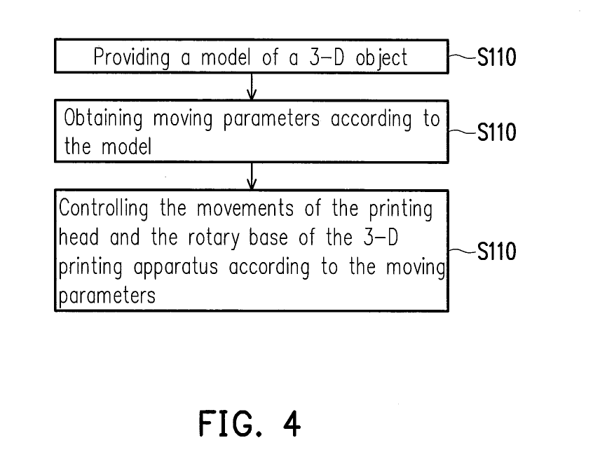

FIG. 4 illustrates a flow chart of a method for fabricating a three-dimensional object by the three-dimensional printing apparatus in FIG. 1. Referring to FIG. 4 and FIG. 1, in the present embodiment, the method for fabricating the 3-D object 10 by the 3-D printing apparatus 100 described above includes the following steps. First of all, a model of the 3-D object 10 is provided (Step S110). The model may be provided by, for example, computer aided design (CAD) or animation modeling software, etc. The model is sliced into a plurality of cross sections for the 3-D printing apparatus 100 to fabricate the 3-D object 10 from the cross sections.

Then, a plurality of moving parameters is obtained according to the model (Step S120). Herein, the moving parameters are obtained from each cross section of the model, and the moving parameters include the rotating parameter θ₁, the first shifting parameter Z₁ and the second shifting parameter Y₁ mentioned above. The moving parameters may be obtained by converting the cross-sectional information of the model into the moving parameters θ₁, Z₁, Y₁ for the 3-D printing apparatus to read and use as a guideline for printing.

Next, the printing head 120 and the rotary base 110 of the 3-D printing apparatus 100 are controlled to move according to the moving parameters (Step S120). The printing head 120 and the rotary base 110 are moved according to the corresponding moving parameters Y₁, θ₁, Z₁ obtained from the cross section of the model. To be specific, the rotary base 110 is controlled to rotate about the first axis A1 according to a rotating parameter θ₁ and shift along the first axis A1 according to the first shifting parameter Z₁, while the printing head 120 is controlled to shift along the second axis A2 according to a second shifting parameter Y₁ to dispense successive layers of building material onto the rotary base 110 to form the 3-D object 10, and the successive layers of building material respectively correspond to the cross sections of the model.

Afterward, the successive layers of building material may be cured by cooling, radiation or any other suitable curing process, so the 3-D object 10 formed by the successive layers of building material is in solid form. The 3-D object 10 is then removed from the rotary base 110 after the curing process.

In sum, the 3-D printing apparatus of the present invention controls the rotary base to shift along and rotate about the first axis, and controls the printing head to shift along the second axis according to the moving parameters obtained from the cross sections of a model of a 3-D object, while the printing head dispenses successive layers of building material onto the rotary base to form the 3-D object from the model. Thereby, unlike the conventional 3-D printing apparatus which the base thereof is not rotatable and can only shift along the X-Y coordinates, the 3-D printing apparatus having the rotatable rotary base can provide better surface qualities without X-Y plane terracing when 3-D models are in circular or curvy shape. Therefore, the 3-D printing apparatus of the present invention has better resolution and better printing quality.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A three-dimensional printing apparatus, suitable for fabricating a three-dimensional object from a model of the three-dimensional object, comprising:
a rotary base, having a carrying surface and configured to rotate about a first axis and shift along the first axis; and
a printing head, disposed above the rotary base and configured to shift along a second axis perpendicular to the first axis for dispensing successive layers of building material onto the carrying surface,
wherein the successive layers of building material form the three-dimensional object, and the dispensing shape of each layer of the building material is decided by the rotation of the rotary base about the first axis, the shifting of the rotary base along the first axis and the shifting of the printing head along the second axis.

2. The three-dimensional printing apparatus as claimed in claim 1, further comprising a control unit, coupled to the rotary base and the printing head for controlling the movements of the rotary base and the printing head.

3. The three-dimensional printing apparatus as claimed in claim 2, wherein the control unit controls the rotary base to rotate about the first axis according to a rotating parameter and controls the rotary base to shift along the first axis according to a first shifting parameter obtained from the model.

4. The three-dimensional printing apparatus as claimed in claim 2, wherein the control unit controls the printing head to shift along the second axis according to a second shifting parameter obtained from the model.

5. The three-dimensional printing apparatus as claimed in claim 3, wherein the control unit controls the printing head to shift along the second axis according to a second shifting parameter obtained from the model.

6. The three-dimensional printing apparatus as claimed in claim 2, further comprising a pulley assembly, coupled to the control unit for carrying the printing head to shift along the second axis.

7. The three-dimensional printing apparatus as claimed in claim 6, wherein the pulley assembly comprises:
a belt, extending along the second axis, the printing head is disposed thereon; and
at least one pulley, connected to the belt for driving the belt to move along the second axis.

8. The three-dimensional printing apparatus as claimed in claim 2, further comprising at least one motor, coupled to the control unit and connected to the rotary base for driving the rotary base to shift along the first axis and rotate about the first axis.

9. The three-dimensional printing apparatus as claimed in claim 2, wherein the motor further comprises a first motor and a second motor, the first motor drives the rotary base to shift along the first axis, and the second motor drives the rotary base to rotate about the first axis.

10. The three-dimensional printing apparatus as claimed in claim 1, wherein the first axis is parallel to a normal vector of the carrying surface.

11. The three-dimensional printing apparatus as claimed in claim 1, wherein the second axis is parallel to the carrying surface.

12. The three-dimensional printing apparatus as claimed in claim 1, further comprising a spool for providing the building material to the printing head.

13. A method for fabricating a three-dimensional object by the three-dimensional printing apparatus as claimed in claim 1, comprising:
providing a model of the three-dimensional object including a plurality of cross sections;
obtaining a plurality of moving parameters according to each cross section of the model; and
controlling the movements of the printing head and the rotary base according to the moving parameters for the printing head to dispense successive layers of building material onto the carrying surface of the rotary base to form the three-dimensional object.

14. The method as claimed in claim 13, wherein the moving parameters comprising a rotating parameter, a first shifting parameter and a second shifting parameter.

15. The method as claimed in claim 14, wherein the step of controlling the movements of the printing head and the rotary base according to the moving parameters comprising:
controlling the rotary base to rotate about the first axis according to a rotating parameter; and
controlling the rotary base to shift along the first axis according to a first shifting parameter obtained from the model.

16. The method as claimed in claim 14, wherein the step of controlling the movements of the printing head and the rotary base according to the moving parameters comprising:
controlling the printing head to shift along the second axis according to a second shifting parameter obtained from the model.

17. The method as claimed in claim 15, wherein the step of controlling the movements of the printing head and the rotary base according to the moving parameters further comprising:
controlling the printing head to shift along the second axis according to a second shifting parameter obtained from the model.

18. The method as claimed in claim 13, wherein the first axis is parallel to a normal vector of the carrying surface.

19. The method as claimed in claim 13, wherein the second axis is parallel to the carrying surface.

20. The method as claimed in claim 13, wherein the successive layers of building material correspond to the cross sections of the model respectively.
